(19) United States
(12) Patent Application Publication
(10) Pub. No.: US 2020/0351935 A1
(43) Pub. Date: Nov. 5, 2020

(54) TRANSPORT INTERFACE MESSAGE PROTOCOL

(71) Applicant: Cisco Technology, Inc., San Jose, CA (US)

(72) Inventors: John T. Chapman, Orange, CA (US); Jennifer Andreoli-Fang, Boulder, CO (US)

(73) Assignee: Cisco Technology, Inc., San Jose, CA (US)

(21) Appl. No.: 16/864,888

(22) Filed: May 1, 2020

Related U.S. Application Data
(60) Provisional application No. 62/842,288, filed on May 2, 2019.
(60) Provisional application No. 62/916,611, filed on Oct. 17, 2019.

(51) Int. Cl. H04W 72/14; H04W 72/12

(52) U.S. Cl. CPC H04W 72/14; H04W 72/1289

(57) ABSTRACT

A transport interface message protocol may be provided. First, a message may be created. The message may comprise data that describes multiple transmissions over an interface that follow a pattern. Then the message may be sent to a computing device. The computing device may provide grants for transmission of the multiple transmissions over a transport network based upon the message.

### RELATED APPLICATIONS

Under provisions of 35 U.S.C. § 119(e), Applicants claim the benefit of U.S. provisional application No. 62/842,288 filed May 2, 2019, which is incorporated herein by reference. Under provisions of 35 U.S.C. § 119(e), Applicant claims the benefit of U.S. provisional application No. 62/916,611 filed Oct. 17, 2019, which is incorporated herein by reference.

### TECHNICAL FIELD

This disclosure relates in general to the field of communications and, more particularly, techniques for integration of wireless access and wireline networks.

### BACKGROUND

Today's communication systems may include separate wireless and wireline portions, each of which may be owned and controlled by different operators. Even though some cable operators, also known as Multiple System Operators (MSOs) use Data Over Cable Service Interface Specification (DOCSIS) networks for backhauling Internet traffic, separate networks, such as mobile core, DOCSIS, and radio, have limited to no visibility into parts of the other network types. Typically, each network type, such as DOCSIS and LTE, have separate traffic scheduling algorithms.

As a result, currently when these types of networks are networks are combined, the resulting architecture may be inefficient and may result in longer latency.

### BRIEF DESCRIPTION OF THE FIGURES

The accompanying drawings, which are incorporated in and constitute a part of this disclosure, illustrate various embodiments of the present disclosure. In the drawings:

FIG. 1A is a block diagram of an operating environment;

FIG. 1B illustrates a transport network comprising LTE/5G backhauling a DOCSIS or PON network.

FIG. 1C illustrates a transport network comprising DOCSIS or PON backhauling an LTE or 5G network.

FIG. 1D illustrates a transport network comprising DOCSIS or PON midhauling an LTE or 5G network;

FIG. 2 is a flow chart of a method for providing a transport interface message protocol;

FIG. 3 is a sequence diagram of a method for providing a transport interface message protocol; and

FIG. 4 is a block diagram of a computing device.

### DETAILED DESCRIPTION

### Overview

A transport interface message protocol may be provided. First, a message may be created. The message may comprise data that describes multiple transmissions over an interface that follow a pattern. Then the message may be sent to a computing device. The computing device may provide grants for transmission of the multiple transmissions over a transport network based upon the message.

Both the foregoing overview and the following example embodiments are examples and explanatory only, and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

A network may have the ability to schedule resources that may recur over time, frequency, or wavelength, or other dimension. A message may be sent to describe the resource scheduled without taking into account of the recurrence. However, sending messages (e.g., Cooperative Transport Interface (CTI) messages) in this manner may be inefficient, may result in too high a message rate or excessively long messages. In order to efficiently describe the resource assignment and balance message frequency and length, a compression process based, for example, on time, frequency, or wavelength, used in DOCSIS, Passive Optical Network (PON), satellite, Wi-Fi, Long-Term Evolution (LTE), 5G, and 6G patterns may be provided by embodiments of the disclosure.

Embodiments of the disclosure may allow one entry in a message (e.g., a CTI message) to describe multiple transmissions over a network interface that follow a specific pattern. The pattern may repeat over time, frequency, wavelength, or other dimensions. An intended use may be to describe the bytes for each symbol or group of symbols within a LTE slot or subframe, a 5G slot, a 6G scheduling interval, a satellite slot or scheduling interval, a DOCSIS MAP, a PON scheduling interval, or a Wi-Fi slot for example. The pattern of bytes per symbol within a 5G slot, for example, may depend upon the 5G use of TDD or FDD. Another use case may be to describe an LTE subframe that may repeat over time.

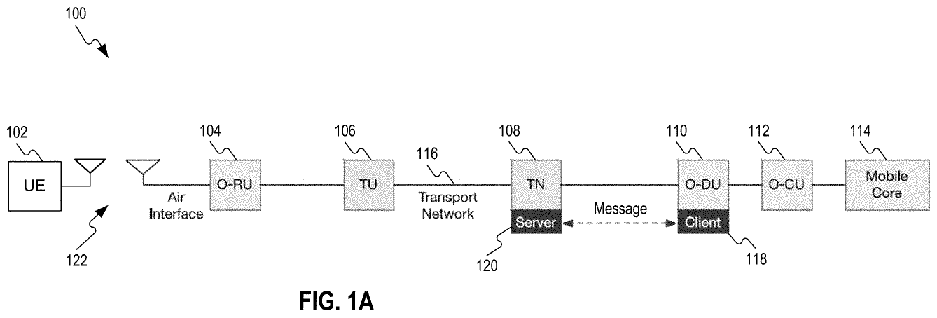

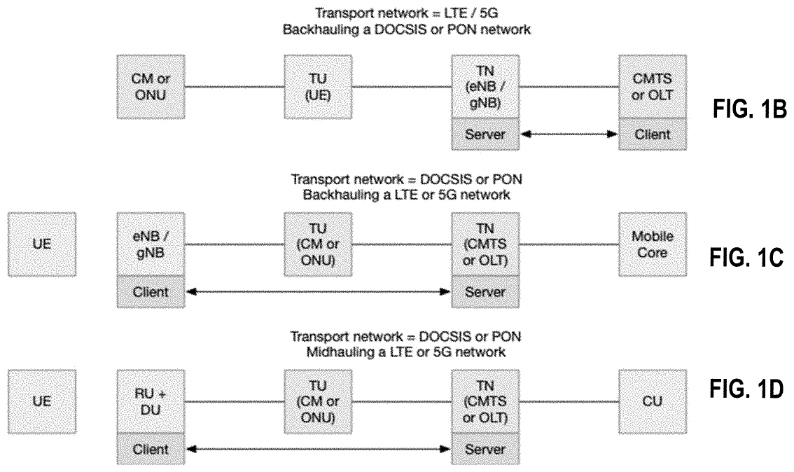

FIG. 1A shows an operating environment 100 for providing a transport interface message protocol. As shown in FIG. 1A, operating environment 100 may comprise a User Equipment (UE) 102, an Open Radio Access Network (O-RAN) Radio Unit (O-RU) 104, a Transport Unit (TU) 106, a Transport Node (TN) 108, an O-RAN Distributed Unit (O-DU) 110, an O-RAN Control Unit (O-CU) 112, a mobile core 114, and a transport network 116. O-DU 110 may include a transport interface client 118 and TN 108 may include a transport interface server 120. UE 102 and O-RU 104 may communicate over an air interface 122. While FIG. 1A illustrates air interface 122, UE 102 and O-RU 104 may communicate over any interface including, but not limited to, a wired interface.

Transport network 116 may comprise any type network including, but not limited to, a network that uses DOCSIS (e.g., a Hybrid Fiber Coaxial (HFC) network, a Passive Optical Network (PON), an Ethernet PON (EPON), a Gigabit PON (GPON), a Service Interoperability in Ethernet PON (SIEPON), a CPON (coherent PON), a Long-Term Evolution (LTE) broadband cellular network, a Fourth Generation (4G) broadband cellular network, a Fifth Generation (5G) broadband cellular network, Wi-Fi, an Integrated Access Backhaul (IAB) network, a microwave network, or a satellite network. TU 106 may comprise, but is not limited to, a User Equipment (UE), an Optical Network Unit (ONU), a modem, or a Cable Modem (CM). TN 108 may comprise, but is not limited to, an LTE eNB or 5G gNB or a LTE or 5G Distributed Unit (DU), an Optical Line Terminal (OLT), Modem Termination System (MTS), or a Cable Modem Termination System (CMTS).

UE 102 may comprise, but is not limited to, a smartphone, a tablet device, a personal computer, a mobile device, a cellular base station, a telephone, a remote control device, a set-top box, a digital video recorder, a cable modem, a network computer, a mainframe, a router, or other similar microcomputer-based device capable of accessing and using transport network 116.

Embodiments of the disclosure may utilize access devices that may provide UE 102 wireless access to operating environment 100 (and ultimately to mobile core 114) via air interface 122. These access devices may comprise, but not limited to, eNodeBs (eNB), gNodeBs (gNB), or Wi-Fi Access Points (AP). The example shown in FIG. 1A illustrates an example where a gNB may be used and distributed in operating environment 100 as O-RU 104, O-DU 110, and O-CU 112.

O-DU 110 may comprise a logical node hosting RLC/MAC/high-PHY layers based on a lower layer functional split. O-RU 104 may comprise a logical node hosting low-PHY layer and Radio Frequency (RF) processing on a lower layer functional split. O-DU 110 may control one or more O-RUs. O-DU may include a scheduler on client 118. For example, for each LTE or 5G slot, O-DU 110 may send scheduling and beamforming commands to O-RU 104 in the form of control plane (c-plane) messages. O-RU 104 may send Uplink (UL) IQ data to O-DU 110 and may receive Downlink (DL) IQ data from O-DU 110, one OFDM symbol at a time.

Consistent with embodiments of the disclosure, a message (e.g., a Bandwidth Report (BWR) message or a Cooperative Transport Interface (CTI) message) may be sent from O-DU 110 and received by TN 108. The message may describe traffic to be sent from UE 102 (or one or more UEs) to O-RU 104, which may then pass to TU 106 and then across transport network 116 to TN 108. Based on the message, TN 108 may schedule one or more grants for transmitting the traffic associated with the message across transport network 116 between TU 106 and TN 108. TU 106 may transmit the traffic based on the scheduled grants. In other words, the message describes the traffic to be sent across transport network 116, before the traffic actually arrives at TU 106. The message may comprise a summary of the grants provided by O-DU 110 to O-RU 104 for traffic coming from UE 102 (or other user equipment). TN 108 and TU 106 may then utilize the messages to ensure grants are in place around the time the traffic has arrived from O-RU at TU 106. Described another way, the message is a mechanism of O-DU 110 to indicate to TN 108 and TU 106 of what will come in the future.

O-RU 104 may have one or more antennas, each of which may have one or more sectors. One or more network interfaces may exist between O-RU 104 and TU 106. O-RU 104 may be responsible for associating byte streams from each antenna/sector to a unique network interface. The message, for example, may describes the byte flow across a single network interface.

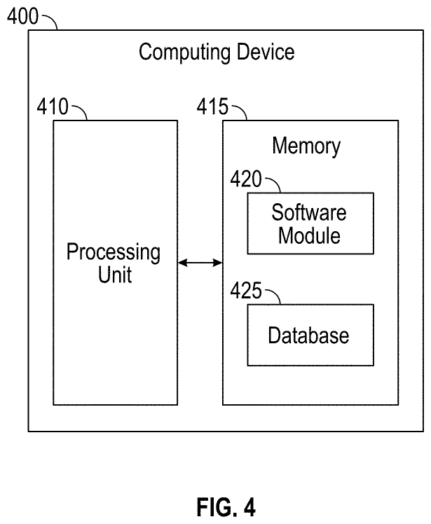

The elements described above of operating environment 100 (e.g., UE 102, O-RU 104, TU 106, TN 108, O-DU 110, O-CU 112, transport interface client 118, and transport interface server 120) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 4, the elements of operating environment 100 may be practiced in a computing device 400.

FIG. 1B, FIG. 1C, and FIG. 1D illustrate other operating environments in which embodiments of the disclosure my operate within. FIG. 1A and its associated description may describe a fronthaul scenario involving a transport network fronthauling mobile traffic. However, pattern descriptors consistent with embodiments of the disclosure may include any recurring traffic pattern (e.g., in time, frequency, wavelength, etc.) that may repeat over time. Fronthaul is an example scenario and other examples may include midhaul or backhaul for example. Moreover, the network that is being transported may comprise any network and may not be limited to mobile, but may be DOCSIS or PON for example.

For example, FIG. 1B illustrates a transport network comprising LTE/5G backhauling a DOCSIS or PON network. In addition, FIG. 1C illustrates a transport network comprising DOCSIS or PON backhauling an LTE or 5G network. Furthermore, FIG. 1D illustrates a transport network comprising DOCSIS or PON midhauling an LTE or 5G network. Notwithstanding, embodiments of the disclosure are not limited to fronthaul and other scenario may be used consistent with embodiments of the disclosure such as midhaul or backhaul for example.

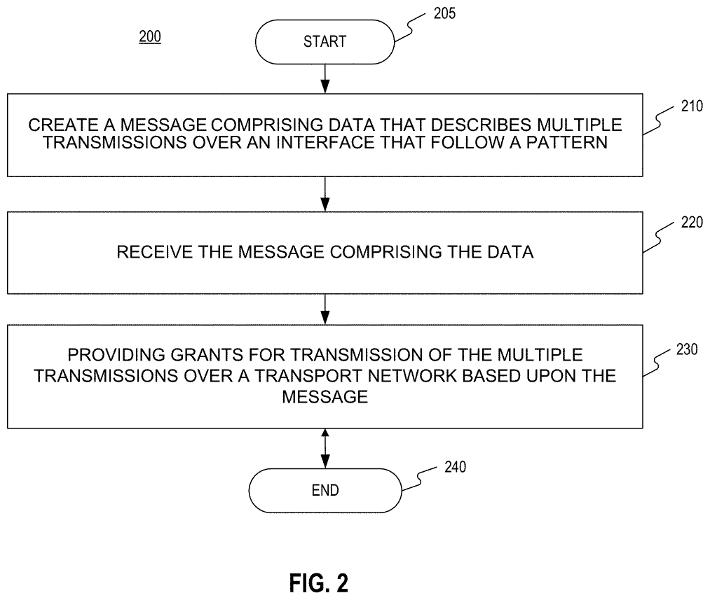

FIG. 2 is a flow chart setting forth the general stages involved in a method 200 consistent with an embodiment of the invention for providing a transport interface message protocol. Method 200 may be implemented using TN 108 and O-DU 110 as described in more detail below with respect to FIG. 1A above. Ways to implement the stages of method 200 will be described in greater detail below.

Method 200 may begin at starting block 205 and proceed to stage 210 where O-DU 110 (e.g., client 118 in O-DU 110) may create a message comprising data that describes multiple transmissions over air interface 122 that follow a pattern. For example, the message may comprise a Bandwidth Report (BWR) message or a Cooperative Transport Interface (CTI) message.

A network may have the ability to schedule resources that may recur over time, frequency, or wavelength, or other dimension. A message may be sent to describe the resource scheduled without taking into account of the recurrence. For example, operating environment 100 may have the ability to schedule bandwidth with the granularity of a 5G OFDMA symbol time. However, sending messages (e.g., CTI messages or BWR messages) at this rate from O-DU 110 to TN 108 (e.g., from client 118 to server 120) may result in too high a message rate. Furthermore, describing bytes for every single symbol may result in excessively long message (e.g., a long CTI message). In order to balance message frequency and length, a compression process based, for example, on 5G TDD/FDD patterns may be provided by client 118.

In providing this compression process, client 118 may allow one entry in a message (e.g., a CTI message) to describe multiple transmissions that come over air interface 122 that follow a specific pattern that are, in turn, sent over transportation network 116. An intended use may be to describe the bytes per symbol for each symbol or group of symbols within a 5G slot for example. The pattern of bytes per symbol within a 5G slot, for example, may depend upon the 5G use of TDD or FDD. The total byte count for a pattern may be contained in a message table entry provided by client 118. If a pattern is used, then the total byte count may be equal to the sum of the bytes per event within the pattern. Notwithstanding, a pattern descriptor, consistent with embodiments of the disclosure, may describe any recurring traffic pattern (e.g., in time, frequency, wavelength, etc.) that repeat over time. The aforementioned fronthaul scenario may describe one scenario, however embodiments of the disclosure are not limited to fronthaul and other scenario may be used consistent with embodiments of the disclosure such as midhaul or backhaul for example.

Client 118 on O-DU 110 may specify a traffic pattern. The traffic pattern may originate, for example, from an LTE/5G slot that contains symbols that contain bytes. The bytes that are included per symbol may depend on the framing type (e.g., TDD or FDD) and may depend on the Quality of Service (QoS) treatment of each byte. Client 118 may generate a pattern using a pattern description language, examples of which are described in the below three examples. Client 118 may send a message to server 120 describing that pattern to server 120. The pattern may have an index. Server 120 may then use that index value with a bytes count. This may be a form of compression.

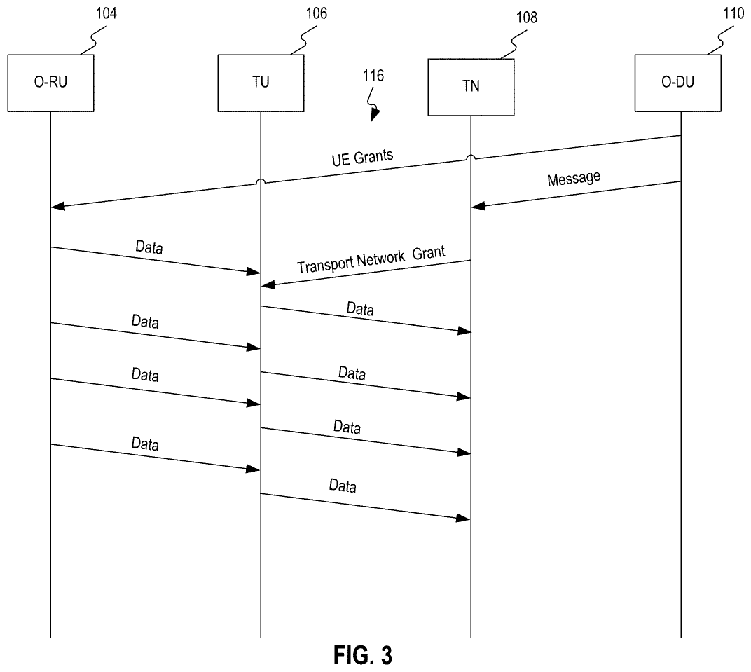

As shown in FIG. 3, while O-DU 110 may have the ability to schedule bandwidth with the granularity of a 5G OFDMA symbol time, for example, sending at this rate from O-DU 110 to TN 108 may result in too high a message rate. A 5G OFDMA symbol time may comprise one example, however, others may be used consistent with embodiments of the disclosure as described above. Furthermore, describing bytes for every single symbol may result in excessively long message. In order to balance message frequency and length, a compression process may be used by O-DU 110. In providing this compression process, client 118 may allow one entry in a message (e.g., a CTI message) to describe multiple transmissions that come over air interface 122 that follow a specific pattern that are, in turn, sent over transport network 116. For example, each of the multiple transmissions my comprise 20 bytes of data. Consistent with embodiments of the disclosure, using pattern detection and compression techniques, O-DU 110 may provide to TN 108 a message that may allow TN 108 to provide a grant for 50 transmissions of the 20 byte multiple transmissions (e.g., 1,000 bytes) in this example. Accordingly, embodiments of the disclosure may lessen the frequency of message exchange and the size of the message.

The following three examples, consistent with embodiments of the disclosure, may show possible compression techniques that may be used. Embodiments of the disclose are not limited to these examples and other compression techniques may be used. In these examples, O-DU 110 may allow one or multiple entry in a message to describe multiple transmissions over air interface 122 that follow a specific pattern. One use may be to describe the bytes per symbol for each symbol or group of symbols within a 5G slot for example. The pattern of bytes per symbol within a 5G slot may depend upon the 5G use of TDD or FDD. The total byte count for a pattern may be contained, for example, in a table entry (e.g., CTI table entry) in the message.

The messages generated by the examples may include a pattern identifier (ID), a pattern duration, a pattern events value, and an event description. The event description may comprise at least one pattern event multiplier and at least one pattern event bytes value. Regarding the pattern ID, this value may uniquely identify a pattern (e.g., CTI pattern). This may allow one entry in the message to describe multiple transmissions over the network interface that follow a specific pattern. The intended use may be to describe the bytes per symbol for each symbol or group of symbols within a 5G slot. For example, the pattern of bytes per symbol within a 5G slot may depend upon the 5G use of TDD or FDD. The pattern duration may describe the length of a single slot time (e.g., a 5G slot time) or a portion of the slot time, or multiple of the slot time.

The pattern events value may describe the number of events per pattern. An event may comprise a symbol or a group of symbols within a slot. For example, if a slot contained 14 symbols, there could be 14 events with each being one symbol or 7 events with each being 2 symbols. Events may be defined to be equally spaced within a duration time with the bytes being delivered at the end of the event.

As stated above, the event description may comprise at least one pattern event multiplier and at least one pattern event bytes value. The pattern event multiplier may comprise a number of sequential events that have the same byte count. The multiplier variable and the byte count variable may be repeated as a pair to describe an event. The pattern event bytes value may comprise the number of bytes per event. A byte count may be allowed to be 0 bytes. A reserved value of 0xFFFF may indicate a Residual Average, where, for example: Residual Average=[CTI byte count−sum(explicit bytes described)/sum(events without explicit bytes described).

Using the above context, the following three examples may be described.

### EXAMPLE 1

### FDD Pattern of 1 ms Slot, 14 Symbols, 1,000 Bytes Per Symbol

Pattern ID=1
Pattern duration=8 (because 8×125 μs=1 ms)
Number of events per pattern=14 (because each symbol is described)
Event description
   Event multiplier=14 (because each event is the same within the pattern)
   Bytes per event=1,000 bytes (because there are 1,000 bytes per symbol)
The byte count is 14,000 bytes. This is the total number of bytes transmitted during the entire slot time.

### EXAMPLE 2

### TDD Receive Pattern of 500 μs Slot; 14 Symbols; 1,000 Bytes on Symbols 0, 1, 2, 10, 11, 12; 0 bytes otherwise.

Pattern ID=2
Pattern duration=4 (because 4×125 μs=500 μs)
Number of events per pattern=14 (because each symbol is described)
Event description
   Event multiplier=3 for symbols 0-2
   Bytes per event=1,000 bytes for each of the first three symbols
   Event multiplier=7 for symbols 3-9
   Bytes per event=0 bytes
   Event multiplier=3 for symbols 10-12
   Bytes per event=1,000 bytes for each of these three symbols
   The entry for symbol 13 is optional because the value is 0 bytes.
The byte count is 6,000 bytes.

### EXAMPLE 3

### 5G 500 μs slot; 200 bytes total of signaling information on symbols 0 and 1; variable but evenly distributed payload on symbols 4 to 7. An event is two symbols. The byte count is 1,000 bytes.

Pattern ID=3
Pattern duration=4 (because 4×125 μs=500 μs)
Number of events per pattern=7 (because each event is described as a pair of symbols)
Event description
   Event multiplier=1 for symbols 0 and 1
   Bytes per event=200 bytes total for the first two symbols
   Event multiplier=1 for symbols 2 and 3
   Bytes per event=0 bytes\
   Event multiplier=2 for symbols 4-7
   Bytes per event=residual average (0xFFFF)
   The entry for symbols 8-1 13 is optional because the value is 0 bytes per symbol.
Residual average=(1,000-200)/2=400 bytes per event
   The total byte count is 1,000 bytes. There were 7 events. Each event is two symbols. The first event was explicitly described as 200 bytes. The next event was explicitly described as 0 bytes. The next two events where declared as residual averages. The last four events were not explicitly described, so they are implicitly considered to be 0 bytes per event. Because each event is two symbols, the byte count for symbols 4-7 is 200 bytes per symbol.

From stage 210, where O-DU 110 creates the message comprising data that describes multiple transmissions over air interface 122 that follow a pattern, method 200 may advance to stage 220 where TN 108 may receive the message comprising the data. For example, client 118 on O-DU 110 may send and server 120 on TN 108 may receive the message.

Once TN 108 receives the message comprising the data in stage 220, method 200 may continue to stage 230 where TN 108 may provide a grant for transmission of the multiple transmissions over transport network 116 based upon the message. For example, as illustrated by FIG. 3, the message (e.g., a CTI message) may describe multiple transmissions that come over air interface 122 that follow a specific pattern that are, in turn, sent over transportation network 116. For example, each of the multiple transmission my comprise 20 bytes of data. Consistent with embodiments of the disclosure, using pattern detection and compression techniques, O-DU 110 may have provided to TN 108 the message that may allow TN 108 to provide a grant to TU 106 for 50 of the 20 byte multiple transmissions (e.g., 1,000 bytes) in this example. Accordingly, embodiments of the disclosure may lessen the frequency of message exchange between O-DU 110 and TN 108 and the size of the message. Once TN 108 provides a grant for transmission of the multiple transmissions over transport network 116 based upon the message in stage 230, method 200 may then end at stage 240.

FIG. 4 shows computing device 400. As shown in FIG. 4, computing device 400 may include a processing unit 410 and a memory unit 415. Memory unit 415 may include a software module 420 and a database 425. While executing on processing unit 410, software module 420 may perform, for example, processes for providing a transport interface message protocol as described above with respect to FIG. 2. Computing device 400, for example, may provide an operating environment for UE 102, O-RU 104, TU 106, TN 108, O-DU 110, O-CU 112, transport interface client 118, or transport interface server 120. UE 102, O-RU 104, TU 106, TN 108, O-DU 110, O-CU 112, transport interface client 118, or transport interface server 120 may operate in other environments and are not limited to computing device 400.

Computing device 400 may be implemented using a Wi-Fi access point, a cellular base station, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay devices, or other similar microcomputer-based device. Computing device 400 may comprise any computer operating environment, such as hand-held devices, multiprocessor systems, microprocessor-based or programmable sender electronic devices, minicomputers, mainframe computers, and the like. Computing device 400 may also be practiced in distributed computing environments where tasks are performed by remote processing devices. The aforementioned systems and devices are examples and computing device 400 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1A may be integrated onto a single integrated circuit. Such a SOC device may include one or more processing units, graphics units, communications units, system virtualization units and various application functionality all of which may be integrated (or “burned”) onto the chip substrate as a single integrated circuit. When operating via a SOC, the functionality described herein with respect to embodiments of the disclosure, may be performed via application-specific logic integrated with other components of computing device 400 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
receiving, by a computing device, a message comprising data that describes multiple transmissions over an interface that follow a pattern; and
providing a grant for transmission of the multiple transmissions over a transport network based upon the message.

2. The method of claim 1, further comprising creating the message.

3. The method of claim 1, wherein the data comprises a pattern identifier

4. The method of claim 1, wherein the data comprises a pattern duration.

5. The method of claim 1, wherein the data comprises a pattern events value.

6. The method of claim 1, wherein the data comprises an event description.

7. The method of claim 6, wherein the event description comprises at least one pattern event multiplier.

8. The method of claim 6, wherein the event description comprises at least one pattern event bytes value.

9. The method of claim 1, wherein the computing device comprises a Transport Node (TN).

10. The method of claim 9, wherein the multiple transmissions occur in at least one of the following scenarios: fronthaul, midhaul, and backhaul.

11. The method of claim 9, wherein the TN comprises one of the following: an Optical Line Terminal (OLT) or a Cable Modem Termination Systems (CMTS) and wherein receiving the message comprises receiving the message from an Open Radio Access Network (O-RAN) Data Unit (O-DU).

12. The method of claim 1, wherein the transport network comprises one of the following: a Data Over Cable Service Interface Specification (DOCSIS) network; a Passive Optical Network (PON); an Ethernet PON (EPON); a Gigabit PON (GPON); a Service Interoperability in Ethernet PON (SIEPON); a Long-Term Evolution (LTE) broadband cellular network; a Fourth Generation (4G) broadband cellular network; a Fifth Generation (5G) broadband cellular network; a Wi-Fi network; an Integrated Access Backhaul (IAB) network; and a satellite network.

13. The method of claim 1, wherein the transport network is disposed between an Transport Node (TN) comprising the computing device and a Transport Unit (TU).

14. The method of claim 13, wherein the TU comprises one of the following:
Optical Network Unit (ONU) and a Cable Modem (CM).

15. The method of claim 1, wherein the interface comprises an air interface between User Equipment (UE) and an Open Radio Access Network (O-RAN) Radio Unit (O-RU).

16. A system comprising:
a memory storage; and
a processing unit coupled to the memory storage, wherein the processing unit is operative to:
receive a message comprising data that describes multiple transmissions over an interface that follow a pattern; and
provide a grant for transmission of the multiple transmissions over a transport network based upon the message.

17. The system of claim 16, wherein the data comprises a pattern identifier (ID), a pattern duration, a pattern events value, and an event description.

18. The system of claim 17, wherein the event description comprises at least one pattern event multiplier and at least one pattern event bytes value.

19. A computer-readable medium that stores a set of instructions which when executed perform a method comprising:
receiving, by a computing device, a message comprising data that describes multiple transmissions over an interface that follow a pattern; and
providing a grant for transmission of the multiple transmissions over a transport network based upon the message.

20. The computer-readable medium of claim 19, wherein the data comprises a pattern identifier (ID), a pattern duration, a pattern events value, and an event description and wherein the event description comprises at least one pattern event multiplier and at least one pattern event bytes value.
